(19) United States
(12) Patent Application Publication
(10) Pub. No.: US 2004/0227932 A1
(43) Pub. Date: Nov. 18, 2004

(54) Large dynamic range shack-hartmann wavefront sensor

(76) Inventor: Geunyoung Yoon, Pittsford, NY (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/778,888

(22) Filed: Feb. 13, 2004

Related U.S. Application Data
(60) Provisional application No. 60/447,344, filed on Feb. 13, 2003.

(51) Int. Cl. G01J 1/00

(52) U.S. Cl. 356/121

(57) ABSTRACT

A wavefront sensor for measuring a wavefront contains an array of lenslets, a detector array, and a mask having a temporally fixed pattern containing one or more opaque regions that are substantially opaque to light from the wavefront. The mask comprises one or more transmissive regions that are transmissive of light from the wavefront. The mask and the array of lenslets are disposed such that light from the wavefront that is transmitted by the transmissive regions is focused by onto the detector array by the array of lenslets. The mask is adapted to be selectably disposed to any one of a plurality of predetermined positions, wherein a different group of lenslets from the array focuses light from the wavefront onto the detector array depending on which of the plurality of predetermined positions is selected.

### CROSS-REFERENCE TO RELATED APPLICATIONS

This application claims the priority benefit of U.S. Provisional Application No. 60/447,344, filed Feb. 13, 2003, the entirety of which is hereby incorporated by reference.

### BACKGROUND OF THE INVENTION

1. Field of the Invention

The present invention is directed to a wavefront measuring device, and more specifically, to a Shack-Hartmann type wavefront sensor with a large dynamic range.

2. Description of the Related Art

The Shack-Hartmann technique is commonly used for determining wavefront shape or error from an ideal planar wavefront. The Shack-Hartmann wavefront sensor is a slope measurement device typically comprising a lenslet array, a two-dimensional detector array, acquisition hardware, and analysis software. Each lenslet in the array receives light from a portion of an incident wavefront. Light from the lenslet is focused within a “virtual” subaperture of the detector array, the detector subaperture generally being defined by those pixels disposed within a projection of the lenslet onto the detector array. The location of the focused light from a particular lenslet within each of these detector subapertures is used to determine the nominal slope of that portion of the incident wavefront. By calculating the slope of the incident wavefront from each spot displacement at each of the lenslets, the shape of the wavefront can be determined.

The dynamic range of a Shack-Hartmann wavefront sensor is typically based on the focal length of the lenslets and the dimensions of the detector subaperture, in units of pixel number, for each lenslet. In prior-art systems, the combination of lenslet focal length and detector subaperture dimensions usually limits the maximum wavefront slope that can be measured. If the slope of a wavefront at one or more of the lenslets exceeds such a predetermined limit, the focus spots from such lenslets move into the subaperture of another lenslet, resulting in one of the following problems: (1) multiple spots are created within a single subaperture, (2) multiple spots overlap within a single subaperture, and (3) spots switching between subapertures. For instance, if the wavefront slope in the area of a first lenslet in the array exceeds this maximum, the light received by the first lenslet produces a focus that is outside the bounds of a corresponding first detector subaperture and is instead received by in a second detector subaperture corresponding to a second lenslet in the array. The presence of the focus from the first lenslet in the second detector subaperture results in an ambiguity, since it cannot be determined, a priori, from which lenslet the focused light came.

Which of the three listed problems is produced depends on what happens with the focus spot from the second lenslet. If the wavefront slope at the second lenslet does not exceed the maximum limit, problems (1) or (2) can result. In the case of problem (1), it is indeterminate which spot belongs to which lenslet. In the case of problem (2), the focus of the second lenslet is indeterminate, since there is insufficient information to determine whether the second focus spot is located at that of another lenslet or the second focus spot is absent. If the wavefront slope at the second lenslet does exceed the maximum limit, problem (3) results. In this case an error can results since the focus spots will usually not be associated with the correct lenslet. These problems can exist between two lenslets or several lenslets.

One solution to increase the dynamic range is to decrease the focal length of lenslets in the lenslet array. The result of such a design choice is to increase the amount of wavefront slope needed to exceed the bounds of the corresponding detector subaperture. The drawback to this choice is that the sensitivity of the wavefront sensor is decreased proportionately if all other system parameters remain the same as they were in the longer focal length lenslet design.

Another method of increasing the dynamic range is suggested in an article by Lindlein, et. al. (“Algorithm for expanding the dynamic range of a Shack-Hartmann sensor by using a spatial light modulator array”, Optical Engineering, 40(5) 837-840 (May 2001)). Lindlein et. al. disclose the use of a spatial light modulator (SLM) to create a sequence of switching patterns that mask differing sets of lenslets in the lenslet array of a Shack-Hartmann sensor. Use of the switching patterns removes the requirement that each lenslet focus light within a detector subaperture. Using the method disclosed by Lindlein et. al., the focus spots formed by light from each lenslet may be located anywhere on the detector, with the exception that “spots are not allowed to overlap”. The authors calculate the minimum number of switching patterns necessary to provide an unambiguous correlation between wavefront slopes and the focus spot locations on a sensor array.

The authors also provide an algorithm for determining which lenslet array subapertures are “switched off” in each switching pattern. For instance, an array of 40 lenslets by 40 lenslets would require nine different switching patterns. Each switching pattern has a form that is different from the other. The Lindlein et. al. method preclude taking a fixed switching pattern and simply moving the pattern to a different coordinate at each step in the sequence.

A need exist, therefore, for providing a simple device and method for resolving ambiguities produced in Shack-Hartmann type wavefront sensor that are created by large wavefront slopes, thus increasing the dynamic range of such wavefront sensors.

### SUMMARY OF THE INVENTION

One way of increasing the dynamic range of a Shack-Hartmann wavefront sensor is by blocking and unblocking individual lenslets within the array thereof in a temporally predetermined manner. While a particular lenslet is blocked, the detector subaperture associated with that lenslet is precluded from receiving light incident on that lenslet. Thus, the detector subaperture for the blocked lenslet is available to receive a signal from another, unblocked lenslet in a potentially unambiguous manner. The blocked lenslet may then be unblocked while simultaneously blocking other lenslets in a prescribed manner. Thus, a predetermined sequence of blocking lenslets within the lenslet array may be used to increase the dynamic range of a Shack-Hartmann wavefront sensor.

One aspect of the present invention involves a device for measuring a wavefront. The device comprises an array of lenslets, a detector,array, and a mask having a temporally fixed pattern containing one or more opaque regions that are substantially opaque to light from the wavefront and one or more transmissive regions that are transmissive of light from the wavefront. The mask and the array of lenslets are disposed such that light from the wavefront that is transmitted by the transmissive regions is focused onto the detector array by the array of lenslets. The mask is adapted to be selectably disposed to any one of a plurality of predetermined positions, wherein a different group of lenslets from the array of lenslets focuses light from the wavefront onto the detector array depending on which of the plurality of predetermined positions is selected.

In yet another aspect of the present invention a method for measuring a wavefront comprises providing a wavefront sensor containing a detector array, an array of lenslets, and a mask having a temporally fixed pattern containing one or more opaque regions that are substantially opaque to light from the wavefront and one or more transmissive regions that are transmissive of light from the wavefront. The method further comprises disposing the array of lenslets such that two lenslets from the array of lenslets are capable of focusing light from the wavefront onto a point on the detector array. The method additionally comprises disposing the mask such that only one of the two lenslets focuses light from the wavefront onto the point.

Another aspect of the present invention involves a method for measuring a wavefront comprises providing a wavefront sensor containing a detector array, an array of lenslets, and a mask having a temporally fixed pattern containing one or more opaque regions that are substantially opaque to light from the wavefront and one or more transmissive regions that are transmissive of light from the wavefront. The method also comprises disposing the mask to a first location wherein a first plurality of lenslets from the array of lenslets focuses light from the wavefront onto the detector array. The method further comprises moving the mask to a second location wherein a second plurality of lenslets from the array of lenslets focus light from the wavefront onto the detector array.

Yet another aspect of the present invention involves a device for measuring a wavefront containing a detector array and a spatial light modulator (SLM) having a first plurality of zones and a second plurality of zones. The first plurality of zones is adapted to substantially block light from a first portion of the wavefront such that light from the first portion of the wavefront is not received by the detector array. The second plurality of zones is adapted to form a plurality of focusing elements that focus light form the wavefront to produce a corresponding plurality of foci on the detector array. The plurality of foci produces a plurality of signals for estimating the slope of the wavefront at the plurality of focusing elements.

Still another aspect of the present invention involves a method for measuring a wavefront comprises providing a wavefront sensor containing a detector array, a lens, and a mask having an aperture adapted to transmit from light from the wavefront. The method additionally comprises disposing the mask to a first location, wherein light from a first portion of the wavefront is transmitted by the aperture and is focused by the lens onto the detector array to produce a first signal. The method further comprises moving the mask to a second location, wherein light from a second portion of the wavefront is transmitted by the aperture and is focused by the lens onto the detector array to produce a second signal. The method also comprises using the first signal to determine the slope of the first portion of the wavefront and using the second signal to determine the slope of the second portion of the wavefront.

### BRIEF DESCRIPTION OF THE DRAWINGS

The foregoing features, aspects, and advantages of the present invention will now be described with reference to the drawings of preferred embodiments that are intended to illustrate and not to limit the invention. The drawings comprise ten figures.

FIG. 1 is a side view of a wavefront sensor for measuring a wavefront according to embodiments of the present invention.

FIG. 2 is a front view of an mask of lenslets used in certain embodiments of a wavefront sensor for measuring a wavefront.

FIG. 3 is a front view of a array used in certain embodiments of a wavefront sensor for measuring a wavefront.

FIG. 4 is a schematic illustration showing a magnified side view of a lenslet and a portion of a detector array for a prior-art Shack-Hartmann wavefront sensor

FIG. 5a is a side view of a prior-art Shack-Hartmann wavefront sensor.

FIG. 5b is a side view of a prior-art Shack-Hartmann wavefront sensor having a larger dynamic range than the wavefront sensor shown in FIG. 4.

FIG. 6 is a side view of wavefront sensor according to an embodiment of the present invention.

FIG. 7 is a front view of mask overlaying a lenslet array as the mask is moved to different locations in accordance with an embodiment of the present invention.

FIG. 8 is a side view of wavefront sensor according to another embodiment of the present invention.

FIG. 9 is a side view of wavefront sensor comprising a single lens and a mask having a single aperture

FIG. 10 is a front view of a spatial light modulator having regions that form lenslets that focus light and other regions that block light.

### DETAILED DESCRIPTION OF THE PREFERRED EMBODIMENT

These and other embodiments of the present invention will also become readily apparent to those skilled in the art from the following detailed description of preferred embodiments having reference to the attached figures; however, the invention is not limited to any particular embodiment(s) disclosed herein. Accordingly, the scope of the present invention is intended to be defined only by reference to the appended claims.

Wavefront Sensor

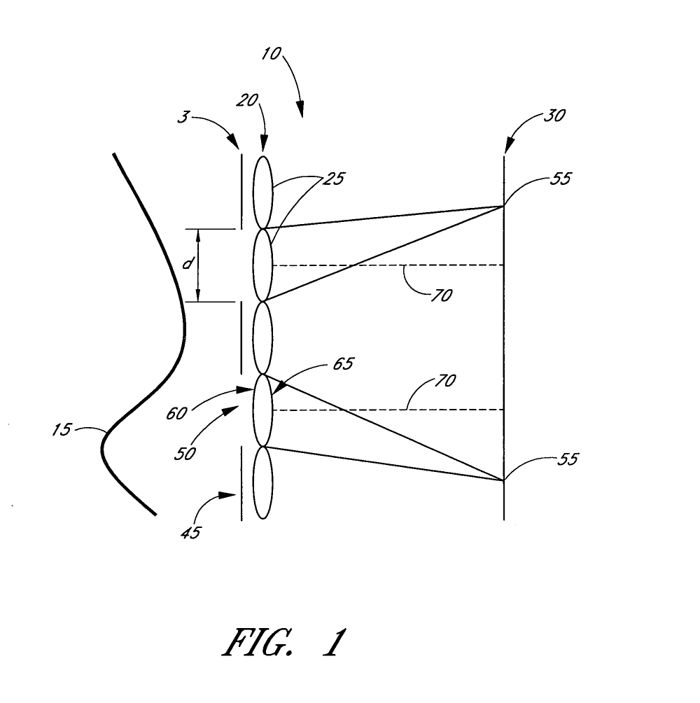

FIGS. 1, 2, and 3 schematically illustrate a wavefront sensor 10 for measuring a wavefront 15. The wavefront sensor 10 comprises an array 20 of lenslets 25, a detector array 30, and a mask 35 having a temporally fixed pattern 40 containing one or more opaque regions 45 that are substantially opaque to light from the wavefront 15 and one or more transmissive regions 50 that are transmissive of light from the wavefront 15. The mask 35 and the array 20 of lenslets 25 are disposed such that light from the wavefront 15 that is transmitted by the transmissive regions 50 is focused by onto the detector array 30 by the array 20 of lenslets 25. The mask 35 is adapted to be selectably disposed to any one of a plurality of predetermined positions, wherein a different group of lenslets 25 from the array 20 focuses light from the wavefront 15 onto the detector array 30 depending on which of the plurality of predetermined positions is selected. The light from the wavefront 15 that is focused on the detector array 30 forms a plurality of focus points 55. The locations of the plurality of focus points 55 may be correlated to the nominal slope of the wavefront 15 over the aperture of each lenslet 25 focusing light from the wavefront 15.

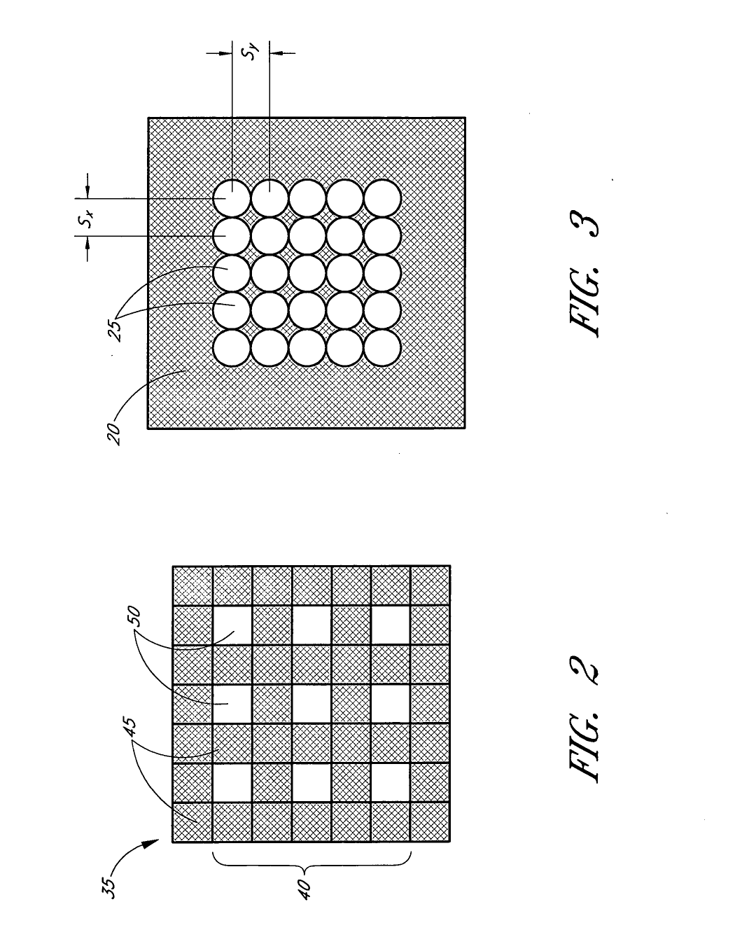

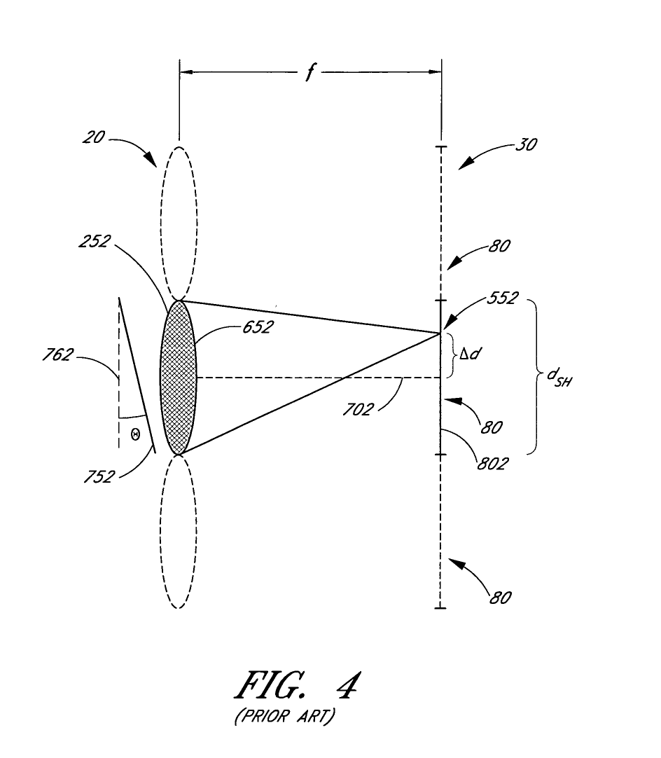

The array 20 of lenslets 25 is preferably disposed in a two-dimensional grid that samples at least a portion of the wavefront 15. For example, FIG. 3 schematically illustrates an embodiment wherein the array 20 of lenslets 25 comprises a grid pattern having 5 rows by 5 columns of lenslets 25. Alternatively, other patterns may be advantageously used, such as a hexagonal pattern. The array 20 may optionally be disposed to form a single row or a single column of lenslets 25. Preferably, the array 20 of lenslets 25 has a fill factor that approaches to one; however, this is not critical to the operation of the wavefront sensor 10, which may, in principal, be used when the array 20 of lenslets 25 has a fill factor that is much less than one. For example, for the array 20 of lenslets 25 illustrated in FIG. 3, each lenslet 25 has a circular cross-section when viewed from the front. In such cases, the fill factor is approximately 0.785 (π/4). Alternatively, each lenslet 25 may have a cross-section that is substantially square or rectangular when viewed from in front of the array 20 of lenslets 25. In such cases, the fill factor is approximately one. Other cross-section may also be used consistent with embodiments of the wavefront sensor 10.

When disposed in the form of a two-dimensional grid, the lenslets have a nominal spacing along the horizontal and vertical axes of the figure of sₓ and s_{y}, respectively. Preferably, the magnitudes of the spacings sₓ, s_{y} are substantially equal, wherein the nominal spacing is designated as s (=sₓ=s_{y});however, unequal values of the magnitudes of the spacings sₓ and s_{y} are also consistent with embodiments of the present invention. The diameter of the lenslets 25 along the horizontal and vertical axes is preferably substantially equal to the magnitudes of the spacings sₓ, s_{y}. The diameters of the lenslets 25 along the horizontal and vertical axes is preferably small enough so that only a small portion of wavefront 15 to be sampled by each lenslet 25. Each lenslet 25 has a diameter that is preferably between about 100 micrometers and 2 millimeters; however, lenslet diameters above or below this range are compatible with embodiments of the invention.

Ordinarily, the array 20 is substantially square and has an equal number of lenslets 25 along the horizontal and vertical axes; however, there is no requirement that either of these conditions be true. For example, if there are more horizontal pixels than vertical pixels for a particular sensor array 30, it may be it desirable to use a array 20 of lenslets 25 that has more horizontal lenslets than vertical lenslets.

In certain embodiments, the wavefront sensor is used to measure a wavefront 15 originating from a human eye. In such embodiments, the array 20 of lenslets 25 is square or rectangular and has horizontal and vertical diameters that are preferably at least about 8 millimeters. In other applications of the wavefront sensor 10, the size and shape of the array 20 may be otherwise configured to conform to predetermined design parameters of the system or wavefront being measured. The number of lenslets along each of the horizontal and vertical axes of the array 20 will depend on the size of the wavefront 15 being measured, the size and focal length of the lenslets 25, and the desired wavefront slope resolution. Generally, the number of lenslets along each of the horizontal and vertical axes of the array 20 preferably in a range of approximately 4 to 80 lenslets. For a given size detector array 30, those skilled in the art can determine the optimum number of lenslets appropriate for a set of design constraints. For instance, as the number of lenslets increases the wavefront slope is measured at more locations over the wavefront 15; however, for a given detector array 30, the number pixels within a subaperture is reduced. This may result in a decrease in the resolution or dynamic range of the wavefront slope measurement. It is envisioned that as the state of the art for the fabrication of lenslet and sensor arrays advances, even larger numbers of lenslets will become both possible and desirable.

In certain embodiments, each of the lenslets 25 focuses light from the wavefront 15 by using refraction. In such embodiments, each lenslet 25 has a front surface 60 and back surface 65 that may be spherical in shape and made of a commonly used optical material such as fused silica or silicon. Alternatively, either or both of the surfaces 60, 65 may be substantially flat or aspheric so as to provide favorable optical and/or fabrication characteristics. In other embodiments, the array 20 of lenslets 25 comprises a diffractive optical element that focuses light from the wavefront 15 based on diffractive interaction with each lenslet.

In certain embodiments, the lenslets 25 each have a nominal focal length of f and a nominal diameter d that is substantially equal to the spacing s of the lenslets 25. Each of the lenslets 25 also has an optical axis 70 defined by a line passing through the center of the lenslet 25 and extending in a direction that is approximately normal to the center portion of the back surface 65 of each lenslet 25.

Various fabrication techniques are common in the art for producing the micro-lenses from which the array 20 of lenslets 25 is comprised. Such techniques include molding technology, ink-jet printing technology, and photolithography. Such techniques may be used produces lenslets 25 are either refractive or diffractive in nature. For instance, one manufacturer uses a photolithographic process that includes designing a gray-scale mask that is used to pattern a photoresist-coated substrate. The gray-scale mask has a high-resolution pattern with a range of optical densities that are used in the photolithographic process to pattern the photoresist. This pattern is then etched into the substrate using a plasma-etch process. Using such processing, the manufacturer can fabricate a lenslet with virtually any desired shape.

The detector array 30 is preferably a one or two dimensional sensor array such as a charge coupled device (CCD) or a complementary metal oxide semiconductor (CMOS) detector array. In certain embodiments, the detector array 30 produces a signal comprising the locations of the plurality of focus points 55 and a computer or similar such device receives the signal for processing information contained in the signal. As used herein, the term “focus point” is a broad term and is used in its ordinary sense and refers, without limitation, to the small area defined by the intersection of light from a focused wavefront with a plane disposed normal to the optic axis of the focusing element and near the circle of least confusion characteristic of such focused wavefronts.

The detector array 30 may additionally comprise a plurality of detector subapertures 80, each detector subaperture 80 corresponding to a lenslet 25 in the array 20. In certain embodiments, the detector subapertures 80 represent a grouping of pixels from detector array 30 rather than a physical boundary. Each detector subaperture 80 generally comprises those pixel of the detector array 30 located within the projection of the corresponding lenslet 25 from the array 20. Preferably, the direction of such a projection from the corresponding lenslet 25 is along the optical axis 70 of the corresponding lenslet 25.

In certain embodiments, the mask 35 comprises a substantially flat substrate such as a plate, film, or sheet having opaque regions 45 and transmissive regions 50. The transmissive regions 50 the mask 35 may comprise areas where material is partially or completely removed from the mask 35. Alternatively, the transmissive regions 50 may comprise a substance or material that transmits at least a portion of light in the waveband of the wavefront 15. The opaque regions 45 preferably comprise a substance or material does not transmit any light in the waveband of the wavefront 15. In certain embodiments, the opaque regions 45 are partially transmissive of light in the waveband of the wavefront 15, but in any event, the amount of light transmitted by the opaque regions 45 is less than the amount of light transmitted by the transmissive regions 50. In other embodiments, the opaque regions 45 transmit light in the waveband of the wavefront 15, but that light is at least partially diffused such that the lenslets 25 corresponding to the opaque regions 45 do not produce focus points 55. Alternatively, in such embodiments, the lenslets 25 corresponding to the opaque regions 45 produce focus points that are sufficiently weak in intensity so as to be distinguished from the focus points 55 corresponding to the transmissive regions.

In certain embodiments, the mask 35 comprises a substrate material that is at least partially transparent to light in the wavefront 15 such as silicon, fused silica, or plastic material. The opaque regions 45 of the mask 35 may comprise a material that is deposited material that is substantially opaque to light in the wavefront 15. For instance a material such as silver or aluminum may be applied to the opaque regions 45 using techniques such as vapor deposition or lithography. In other embodiments, a paint, ink, or other suitable pigment may be applied to one of both sides of the mask 35 to provide the opaque regions 45.

In yet other embodiments, the mask 35 comprises a substrate material that is substantially non-transmissive of light in the wavefront 15 such as a plastic material. In such embodiments, the transmissive regions 50 of the mask 35 may be formed by physically removing some of the substrate material from those regions. Alternatively, the optical properties of substrate material in the transmissive regions 50 may be altered chemically so that those regions of the mask 35 are more transmissive of light in the wavefront 15.

In still other embodiments, the polarization characteristics of the mask 35 are varied such that the opaque regions 45 and the transmissive regions 50 appropriately block and transmit polarized light from the wavefront 15. Alternatively, the transmissive regions 50 of the mask 35 do not directly transmit light from the wavefront 15, but comprise a material, such as a fluorescent dye, that absorbs energy from the wavefront 15 and remits light that is directed to the detector array 30.

In other embodiments, the mask 35 comprises a spatial light modulator (SLM) or similar such device having opaque regions 45 and transmissive regions 50. In such embodiments, the opaque regions 45 are defined as those regions of the SLM in which light from the wavefront 15 passing through the SLM changes polarization by an amount sufficient to substantially preclude transmission through a polarizer located at the output of the SLM. In such embodiments, the transmissive regions 50 are defined as those regions of the SLM in which light from the wavefront 15 passing through the SLM changes polarization by an amount sufficient to be at least partially transmitted by through the polarizer located at the output of the SLM. The SLM may comprise a liquid crystal display (LCD), an array of addressable micro-mirrors, or another similarly such pixelated device that addressably varies one or more optical properties (e.g., polarization, phase, attenuation) over the surface of an incident wavefront.

In certain embodiments, the pattern 40 of the mask 35 is temporally fixed. The term “temporally fixed” as used herein and applied to the pattern 40 refers, without limitation, to a pattern in which the overall shape and size of the pattern and the components thereof (e.g., the opaque regions 45 and the transmissive regions 50 of the mask 35) do not substantially change over time. In certain embodiments, as discussed in greater detail herein below, the pattern 40 of the mask 35 is temporally fixed and spatially variable. The terms “spatially variable” and “varied spatially” as used herein and applied to the pattern 40 refers, without limitation, to a pattern that changes position over time, while the overall shape and size of the pattern and the components thereof remain substantially constant.

The apertures created on the mask 35 by the transmissive regions 50 preferably have substantially the same area and shape as the lenslets 25 when view from the front. Alternatively, each of the transmissive regions 50 may have an area and extent that is smaller than the individual lenslets 25 in the array 20, such as shown for the two-dimensional mask in FIG. 2. In some embodiments, the transmissive regions 50 have a size, shape, and extent consistent with certain performance and/or fabrication constraints.

As illustrated in FIG. 1, the mask 35 may be disposed such that the array 20 of lenslets 25 is between the mask 35 and the detector array 30. In such configurations, it is preferred, but not required, that the transmissive regions 50 do not transmit any light in the waveband of the wavefront 15. Alternatively, the mask 35 may be disposed such that the mask 35 is between the array 20 of lenslets 25 and the detector array 30.

Shack-Hartmann Wavefront Sensor

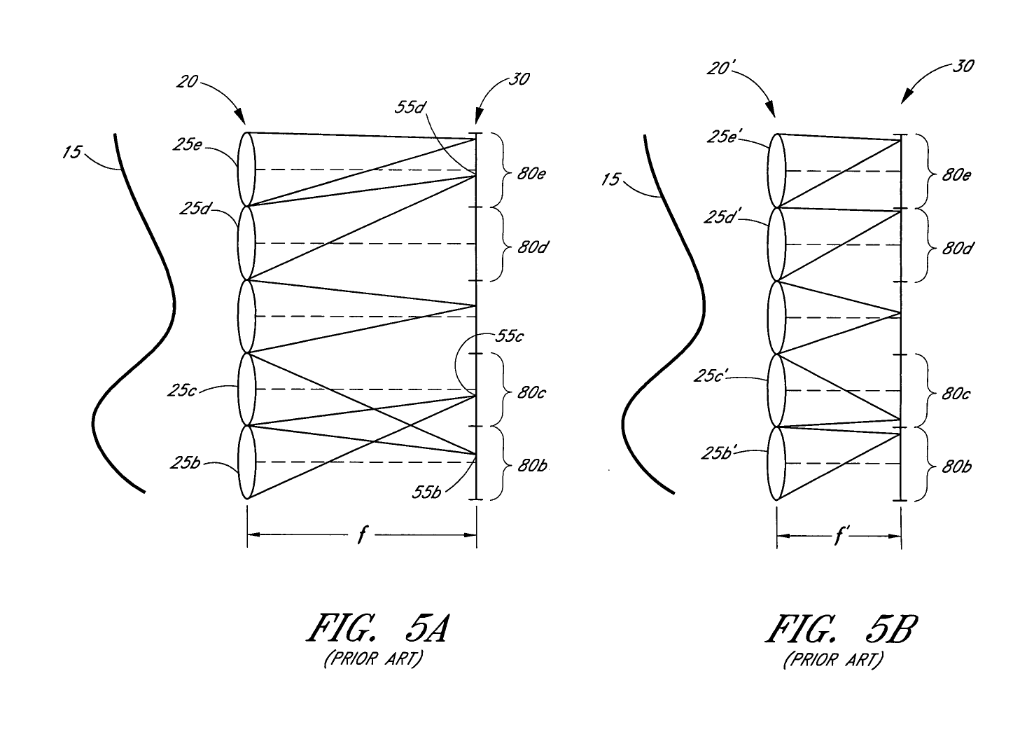

FIG. 4 is a schematic illustration showing a magnified side view of a lenslet 25a and a portion of the detector array 30 for a prior-art Shack-Hartmann wavefront sensor illustrating how the lenslets 25a focuses light from a portion 75a of the wavefront 15 onto a detector subaperture 80a of the detector array 30. The detector subaperture 80a has a width d_{SH} along the axis shown in FIG. 4. The lenslet 25a has a nominal focal length of f and a nominal diameter that is substantially equal to the spacing between the lenslets of the lenslet array 20. The lenslet 25a also has an optical axis 70a defined by a line passing through the center of the lenslet 25a and extending in a direction that is approximately normal to the center portion of the back surface 65a of the lenslet 25a.

The portion 75a of the wavefront 15 enters the lenslet 25a at an angle θ relative to a line 76a that is substantially perpendicular to the optic axis 70a (for purposes of this illustration, angular component of the portion 75a along a line into the page of FIG. 4 is assumed to be zero). The portion 75a is focused onto the detector subaperture 80a to form a focus point 55a located a distance Δd from the intersection of the optical axis 75a with the detector subaperture 80a. The angle θ may be approximately correlated to the distance Δd by the relationship:

θ=atan (Δd/f) (1)

where Δd and f have the same dimensional units. When the angle θ is approximately zero, then Δd is also approximately zero and the focus point 55a is located at the intersection of the optical axis 70a with the detector subaperture 80a. When θ is positive, as shown in FIG. 4, Δd has a positive value that increases as θ increases. In a Shack-Hartmann wavefront sensor it is generally required that the distance Δd be less than one-half the detector subaperture width d_{SH}, since a larger value of Δd would mean that the focus point 55a was in the detector subaperture of an adjacent lenslet from the lenslet array, thus producing either an error or an ambiguity.

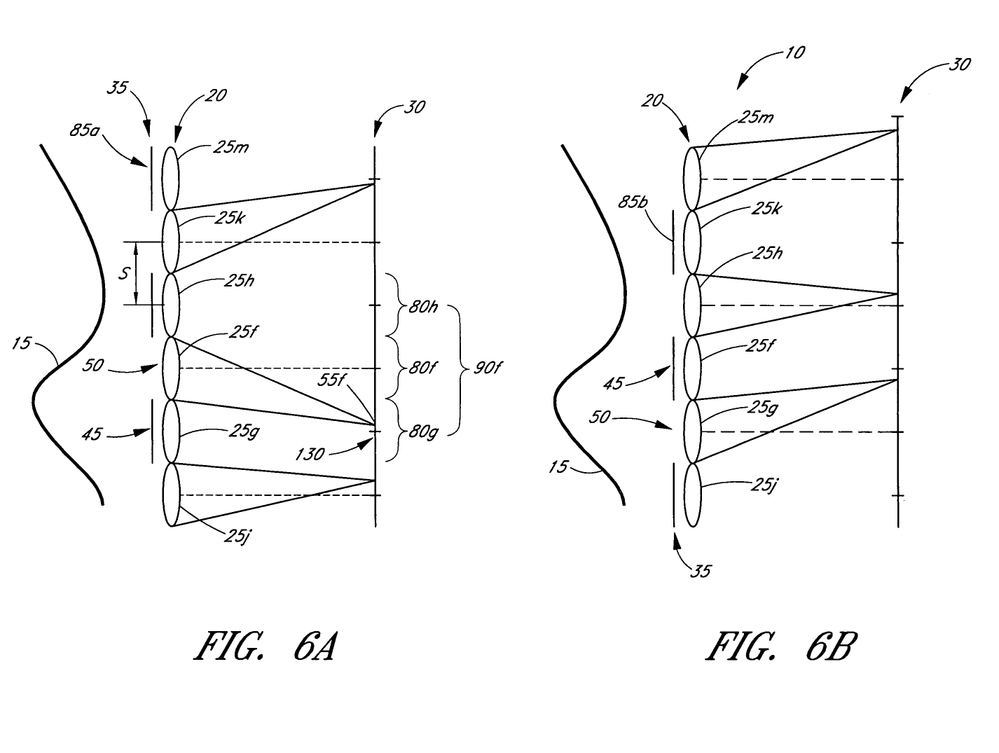

FIG. 5a illustrates two possible problems that can be produced using a prior-art Shack-Hartmann wavefront sensor when the incident wavefront has portion in which the slope exceeds a predetermined limit. In the first instance, light from the wavefront 15 is focused by the lenslets 25b and 25c to form the focus points 55b and 55c. However, the location of the focus points 55b, 55c are switched from the expected values and are located inside the detector subaperture 80c and 80b, respectively. This creates an error, since a calculation of the local wavefront slope based on Equation 1 assumes, in this case incorrectly, that the focus point 55b is from light focused by the lenslet 25b and visa versa.

In the second instance, light from the wavefront 15 is focused by the lenslets 25d and 25e to form the focus points 55d and 55e. However, the focus points 55d and 55e are both disposed inside the detector subaperture 80e. This situation creates two ambiguities. First, since there is no focus point inside the detector subaperture 80d, the local slope of the wavefront at the lenslet 25d is indeterminate. Second, since there are two focus points (55d and 55e) inside the detector subaperture 80e, the local slope of the wavefront at the lenslet 25e is also indeterminate, since it cannot be determined which of the focus points 55d, 55e should be used to calculate the local wavefront slope for the portion received by the lenslet 25e.

Other problems of a similar nature may also be produced when the incident wavefront has portion in which the slope exceeds a predetermined limit. For instance, two focus points may completely or partially overlap one another, making it difficult or impossible to either detect or resolve two focus points. In the former case, only one focus point is detected and there are fewer focus points than there are lenslets. Also, a local wavefront slope into one or more of the lenslets 25 may be so great that the some of the focus points may are disposed at locations that are even beyond any of the adjacent detector subapertures.

FIG. 5b illustrates one prior-art method of solving the problems illustrated in FIG. 5a. The prior-art solution is to replace the lenslet array 20 with a different lenslet array 20′, wherein each of the lenslets 25′ has focal lengths of f′ that is less than f Using this approach, light from lenslets 25b′, 25c′, and 25d′ all remain within their corresponding detector subapertures 80b, 80c, and 80d. While the problems associated with large wavefront slope may be resolved with this approach, this approach may also result in a lower slope resolution if the same detector array 30 having the same pixel resolution is used.

Principle of Operation

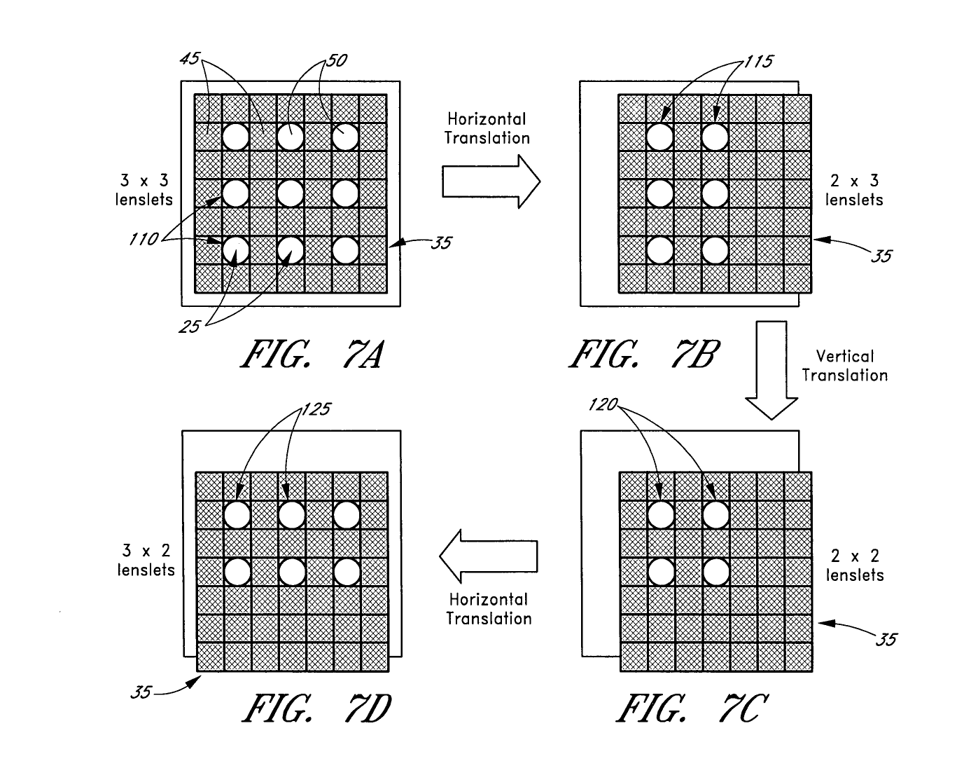

FIG. 6 may be used to illustrate how the mask 35 can increase the dynamic range of the wavefront sensor 10 as compared to a prior-art Shack-Hartmann wavefront sensor using a detector array equivalent to the detector array 30 and lenslets equivalent to the lenslets 25. FIG. 6 shows a lenslet 25f that may be used to focus light form the wavefront 15 onto the detector array 30. Two lenslets 25g, 25h are disposed to either side of the lenslet 25f. Two more lenslets 25j, 25k are disposed adjacent to the lenslets 25g, 25h, respectively, on the side opposite lenslet 25f. For a traditional Shack-Hartmann sensor not having the mask 35, the detector subapertures 80f, 80g, 80h shown in FIG. 6a represent the portions of the detector array 30 that may be used by the corresponding lenslets 25f, 25g, 25h to focus light from the wavefront 15.

For this illustrative example, each transmissive region 50 has a width that is substantially equal to the spacing s of the lenslets 25, and the transmissive regions 50 are arranged such that every other lenslet 25 from the array 20 focuses light from the wavefront 15 onto the detector array 30. Thus, when the mask 35 is disposed to a first position 85a, as shown in FIG. 6a, the lenslets 25f, 25j, 25k focus light onto the detector array 30, while the lenslets 25g, 25h and a lenslet 25m are prevented from focusing light onto the detector array 30. When the mask 35 is disposed to a second position 85b, as shown in FIG. 6b, the lenslets 25g, 25h, 25m focus light onto the detector array 30, while the lenslets 25f, 25j, 25k are prevented from focusing light onto the detector array 30.

When the mask 35 at the first position 85a, the lenslet 25f is focuses light from the wavefront 15 onto the detector array 30, while the adjacent lenslets 25g, 25h are prevented from focusing light from onto the detector array 30 by the opaque regions 45 of the mask 35. Since the adjacent lenslets 25g, 25h do not focus light onto the detector array 30, the portion of the detector array 30 that is available to the lenslet 25f for making wavefront slope measurements is an effective detector subaperture 90f, which is seen to be larger than the detector subaperture 80f.

The extent of the effective detector subaperture 90f along the face of the detector array 30 is from the centers of the adjacent detector subapertures 80g, 80h. The extent of the effective detector subaperture 90f is limited in this way because the adjacent lenslets 25j, 25k utilize the other half of the detector subapertures 80g, 80h, respectively. The size of the effective detector subaperture 90f is approximately twice the size of the detector subaperture 80f (i.e., the subaperture of lenslet 25f without the mask 35). Therefore, in this example, the dynamic range for the lenslet 25f, in terms of the maximum wavefront slope that can be measured, is approximately twice that of an equivalent prior-art Shack-Hartmann wavefront sensor not using the mask 35. In similar fashion, the dynamic range of the other lenslets 25 in the array 20 corresponding to the transmissive regions 50 of the mask 35 (e.g., the lenslets 25j, 25k in FIG. 6a) also have a dynamic range that is approximately twice that of an equivalent prior-art Shack-Hartmann wavefront sensor does not use the mask 35.

Continuing the illustrative example, FIG. 6b shows the mask 35 at the second position 85b. The lenslets 25g, 25h, 25m, which were previously prevented from focusing light from the wavefront 15 onto the detector array 30, now focus light form the wavefront 15 onto the detector array 30, while the adjacent lenslets 25f, 25j, 25k are prevented from focusing light onto the detector array 30. Since the adjacent lenslets 25f, 25j, 25k do not focus light, the dynamic range of lenslets 25g, 25h, 25m also have a dynamic range that is approximately twice that of an equivalent prior-art Shack-Hartmann wavefront sensor does not use the mask 35. Thus, all the lenslets 25 of the array 20 have a dynamic range that is approximately twice that of an equivalent prior-art Shack-Hartmann wavefront sensor does not use the mask 35 (i.e., half the lenslets 25 when the mask 35 is located at the first position 85a and the other half of the lenslets 25 when the mask 35 is located at the second position 85b).

Mask Step Method

In certain embodiment, a method for measuring the wavefront 15, herein referred to as the mask step method, comprises a first step of providing the wavefront sensor 10. The method further comprises a second step of disposing the mask 35 to the first location 85a wherein a first plurality of lenslets (e.g., lenslets 25j, 25f, 25k in FIG. 6) from the array 20 of lenslets 25 focus light from the wavefront 15 onto the detector array 30. The method further comprises a third step of moving the mask 35 to the second location 85b, wherein a second plurality of lenslets 105 (e.g., lenslets 25g, 25h, 25m in FIG. 6) from the array 20 of lenslets focus light from the wavefront 15 onto the detector array 30.

The use of six lenslets 25 in FIG. 6 is for illustrative purposes only. Generally, the number of lenslets 25 in the array 20 is larger than the six lenslets shown in FIG. 6, although the mask step method may be used when the array 20 comprises as few as two lenslets 25. Using the mask step method, each of the lenslets 25 in the array 20 is provided with an effective subaperture (e.g., the effective detector subaperture 90f) that is larger than the subaperture provided by an equivalent prior-art Shack-Hartmann sensor not having the mask 35 (e.g., the detector subaperture 80f).

In certain embodiments, the detector subapertures 80 are in the form of a one-dimensional array and the pattern 40 of the mask 35 is configured as in FIG. 6 wherein every other lenslet of the array 20 focuses light from the wavefront 15 onto the detector array 30. In such embodiments, the mask step method is used once to provide an increased dynamic range compared to a Shack-Hartmann type wavefront sensor that does not use this method.

In other embodiments, the pattern 40 of the mask 35 is configured wherein every nth lenslet of the array 20 focuses light onto the detector array 30. In such embodiments, the third step of the mask step method above may be repeated (n−2) times in order that each lenslets 25 in the array 20 focuses light form the wavefront 15 sometime during the method.

In yet other embodiments, the array 20 of lenslets 25 and detector subapertures 80 are in the form of a two-dimensional arrays and the third step of the mask step method is repeated sufficient times so that each lenslet 25 focuses light from the wavefront 15 at least once during the method. In such embodiments, the pattern 40 of the mask 35 comprises a two-dimensional pattern 40. For example, the mask 35 illustrated in FIG. 2 comprises the two-dimensional pattern 40 shown and may be used in conjunction with the 5×5 array 20 of lenslets 25 shown in FIG. 3.

Two-dimensional Mask Step Method

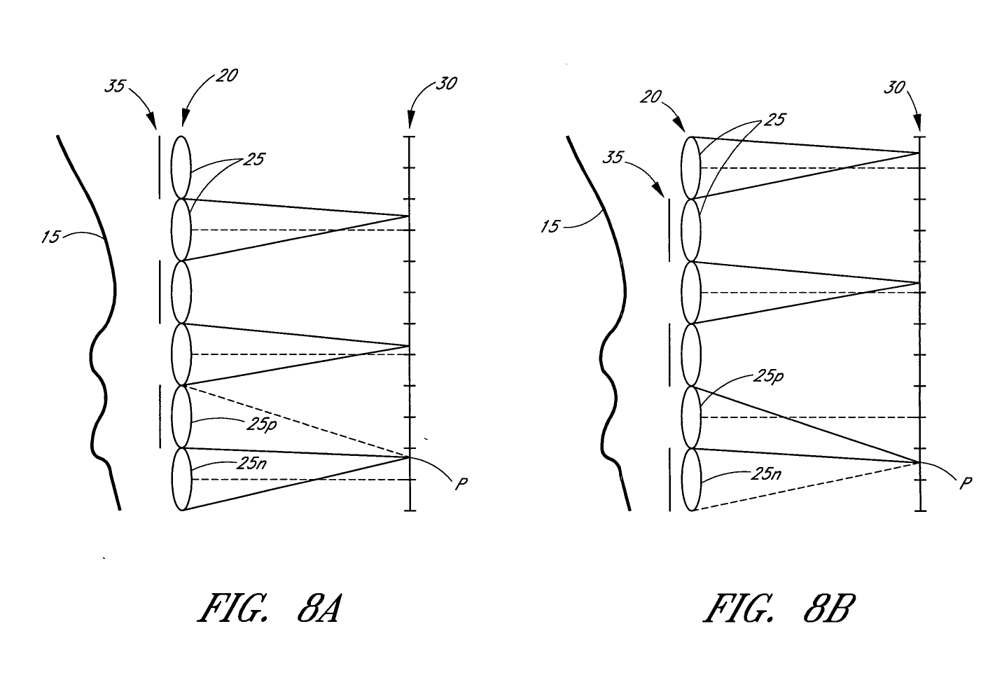

FIG. 7 may be used to illustrate one method of using the two-dimensional pattern 40 of the mask 35 shown in FIG. 2. Since FIG. 7 is a front view of the wavefront sensor 10, the wavefront 15 is not shown. Likewise, the detector array 30 is not shown in FIG. 7 since it is located behind and, therefore, hidden by the mask 35 and the array 20 of lenslets 25.

Referring to FIG. 7, a preferred embodiment of the present invention comprises a method for measuring the wavefront 15, wherein the mask 35 comprises a two-dimensional pattern 40. The method, referred to herein as the two-dimensional mask step method, comprises a first step of providing the wavefront sensor 10. The method further comprises a second step of disposing the mask 35 to a first location (e.g., that shown in FIG. 7a), wherein a first plurality of lenslets 110 from the array 20 focuses light from the wavefront 15 onto the detector array 30. The method further comprises a third step of moving the mask 35 to a second location (e.g., that shown in FIG. 7b), wherein a second plurality of lenslets 115 from the array 20 focuses light from the wavefront 15 onto the detector array 30. The method further comprises a fourth step of moving the mask 35 to a third location (e.g., that shown in FIG. 7c), wherein a third plurality of lenslets 120 from the array 20 focuses light from the wavefront 15 onto the detector array 30. The method further comprises a fifth step of moving the mask 35 to a fourth location (e.g., that shown in FIG. 7d), wherein a fourth plurality of lenslets 125 from the array 20 focuses light from the wavefront 15 onto the detector array 30.

The two-dimensional mask step method utilizes a mask 35 having a temporally fixed pattern 40 that is spatially varied by moving the mask 35 to four different locations. During steps 2-5 of the method, the mask 35 is moved such that each transparent region 50 defines a 2×2 sub-array of lenslets 25, wherein each lenslet 25 in the sub-array successively focus light from the wavefront 15 onto the detector array 30. Using the method, each of the lenslets 25 in the array 20 has a corresponding effective detector subaperture 90 that has approximately four times more area on the detector array 30 than the corresponding detector subaperture 80 provided by an equivalent prior-art Shack-Hartmann sensor not utilizing the two-dimensional mask step method. Thus, the wavefront sensor 10 is able to measure larger wavefront slopes without ambiguity than the equivalent Shack-Hartmann sensor that does not incorporate the mask 35.

The two-dimensional mask step method, using the pattern 40 shown in FIG. 2, may be used to remove ambiguities produced by prior-art Shack-Hartmann sensors occurring when local wavefront slopes cause light received by a lenslet to be focused onto the subaperture of an adjacent lenslet. Using the pattern 40 shown in FIG. 2, no ambiguity is produced so long as the focused light does not lie beyond the center of an adjacent subaperture corresponding to an adjacent lenslet. For example, if the mask 35 shown in FIG. 6 represents one row or column of a two-dimensional pattern 40, the two-dimensional mask step method produces no ambiguity when the focus point 55f produced by the lenslet 25f does not lie beyond the point 130 on the detector subaperture 80g, wherein the point 130 represents the intersection of detector array 30 with the optical axis of the lenslet 25g.

Modified Two-Dimensional Mask Step Method

In certain embodiments, the temporally fixed pattern 40 is configured such that the two-dimensional pattern 40 comprises a set of m transmissive regions 50 configured such that the spacing between the transmissive regions 50 along each of two orthogonal axes is every nth lenslet 25 of the array 20. Using this pattern the mask 35 may be moved in such a manner that each transparent region 50 defines an area that covers an n×n sub-array of lenslets 25, wherein each lenslet 25 in the n×n sub-array successively focus light from the wavefront 15 onto the detector array 30. In certain embodiments, such a pattern 40 is used in conjunction with modified version of the two-dimensional mask step method, referred to herein as the modified two-dimensional mask step.

The modified two-dimensional mask step method comprises a first step of providing the two-dimensional pattern 40 on the mask 35 having the set of m transmissive regions 50 configured such that the spacing between the transmissive regions 50 along each of two orthogonal axes is every nth lenslet 25 of the array 20. The size of each transmissive region is preferably substantially equal to that of an individual lenslet 25. The method comprises a second step of disposing the mask 35 to the first location wherein a first plurality of lenslets 25 from the array 20 focus light from the wavefront 15 onto the detector array 30. The method further comprises a third step of moving the mask 35 to (n²−1) different positions such that each of the m transmissive regions 50 allows light from the wavefront 15 to be focused onto the detector array 30 by each lenslet 25 within an n×n sub-array of lenslets 25.

Using the modified two-dimensional mask step method, each of the lenslets 25 in the array 20 has a corresponding effective detector subaperture 90 that has approximately n² times more area on the detector array 30 than the corresponding detector subaperture 80 provided by an equivalent prior-art Shack-Hartmann sensor not utilizing the two-dimensional mask step method. Thus, the wavefront sensor 10 is able to measure larger wavefront slopes without ambiguity than the equivalent Shack-Hartmann sensor that does not incorporate the mask 35.

When using the either the two-dimensional mask step method or the modified two-dimensional mask step method, the mask 35 may be located either in front of or behind the array 20 of lenslets 25. Other methods utilizing different algorithms for moving the mask 35 may alternatively be used in conjunction with the various embodiments of the temporally fixed patterns 40 discussed above herein. Also, different embodiments of the temporally fixed patterns 40 may be used to increase the dynamic range of the device 10 over prior-art Shack-Hartmann wavefront sensors not utilizing the mask 35.

In certain embodiments, the mask 35 comprises an SLM and the two-dimensional, temporally fixed pattern 40 is produced by addressing the pixels of the SLM in a predetermined manner using an appropriate electronic input into the SLM. In such embodiments, the pattern 40 is spatially varied by varying the electronic input into the SLM in a predetermined manner such that the pattern 40 is moved spatially, but is unchanged in terms of the overall shape and size of the pattern and the components thereof.

Point Ambiguity Elimination Method

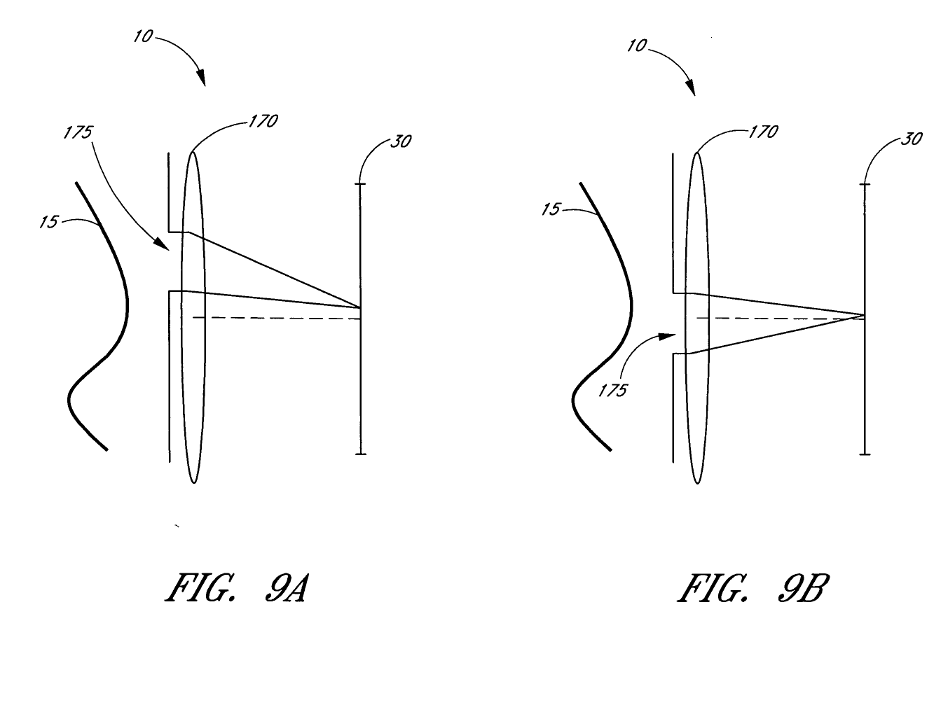

FIG. 8 may be used to describe another embodiment of the present invention, wherein a method for measuring the wavefront 15 comprises a first step of providing the wavefront sensor 15 and disposing the array 20 of lenslets 25 such that two of lenslets 25n, 25p are capable of focusing light from the wavefront 15 onto a point P on the detector array 30. The method additionally comprises a second step of disposing the mask 35 such that only one of the two lenslets 25 focuses light from the wavefront 15 onto the point P.

As illustrated in FIG. 8, the wavefront 15 is disposed such that the lenslets 25n, 25p are both capable of focusing light onto the point P on the detector array 30. In FIG. 8a the mask 35 is positioned so that only light from the wavefront 15 entering the lenslet 25n is focused onto the point P. The dotted line from lenslet 25p indicates light from the wavefront 15 that would be focused to the point P on the detector array 30 if the mask 35 were removed or moved to another position such as that shown in FIG. 8b. In FIG. 8b the mask 35 is positioned so that only light from the wavefront 15 entering the lenslet 25p is focused onto the point P. The dotted line from lenslet 25n indicates light from the wavefront 15 that would be focused to the point P on the detector array 30 if the mask 35 were removed or moved to another position such as the position shown in FIG. 8a.

Using the two different positions of the mask 35, it can be determined that the light contained in the point P is produced by light from the wavefront 15 that is focused by both the lenslet 25n and the lenslet 25p. Therefore, the signal produced by focused light at the point P on the detector array 30 may be used to determine the average slope of the wavefront 15 within the areas corresponding to the lenslets 25n, 25p.

Single Aperture Method

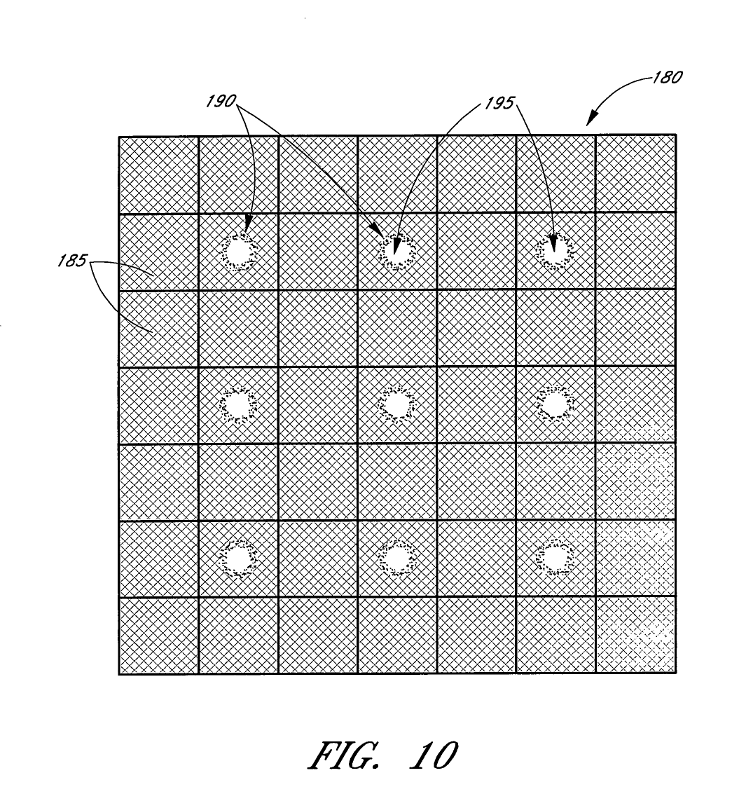

In certain other embodiments, such as that shown in FIG. 9, the array 20 of lenslets 25 is replaced by a single lens 170 and the wavefront sensor 10 contains a mask 35 that comprises an aperture 175 adapted to transmit from light from the wavefront 15. The lens 170 preferably has a diameter that is at least equivalent to the largest dimension of the array detector 30 (e.g., the diagonal length of a rectangular or square array detector). The lens 170 may be a refractive element comprising a single material or a achromatic lens comprising two or more materials. Alternatively, the lens 170 may any suitable imaging optical element such as a compound lens, curved mirror, holographic optical element, or diffractive optical element.

The aperture 175 is typically circular or square with a diameter that is sufficiently small so that light from only a small portion of the wavefront 15 is received by lens 170. The diameter of the aperture 175 is preferably less than about 3 millimeter, more preferably less than about 1 millimeter, and even more preferably less than about 500 micrometers.

The wavefront sensor 10 schematically illustrated in FIG. 9 may be used in a method for measuring a wavefront comprising a first step of providing a wavefront sensor 10 that comprises the detector array 30, the lens 170, and the mask 35 having the aperture 175. The method additionally comprises a second step of disposing the mask 35 to a first location, wherein light from a first portion of the wavefront 15 is transmitted by the aperture 175 and is focused by the lens 170 onto the detector array 30 to produce a first signal. The method further comprises a third step of moving the mask 35 to a second location, wherein light from a second portion of the wavefront 15 is transmitted by the aperture 175 and is focused by the lens 170 onto the detector array 30 to produce a second signal. The method also comprises a fourth step of using the first signal to determine the slope of the first portion of the wavefront 15 and using the second signal to determine the slope of the second portion of the wavefront 15.

SLM Methods

In certain embodiments, such as that shown in FIG. 10, the array 20 of lenslets 25 is incorporated into the mask 20. In such embodiments, the wavefront sensor 10 comprises an SLM 180 having a first plurality of zones 185 and a second plurality of zones 190. The first plurality of zones 185 is adapted to substantially block light from a first portion of the wavefront 15 (not shown) such that light from the first portion of the wavefront 15 is not received by the detector array. The second plurality of zones 190 is adapted to form a plurality of focusing elements 195 that focus light form the wavefront 15 to produce a corresponding plurality of foci on the detector array 30. The plurality of foci produces a plurality of signals that may be used for estimating the slope at a plurality locations on the wavefront 15 corresponding to the locations of the plurality of focusing elements 165. The SLM 180 may be alternatively used in any of the previous embodiments of the wavefront sensor 10 disclosed above herein to replace the mask 35 and the array 20 of lenslets 25. The SLM 180 may also be for any of the methods discussed above herein utilizing the wavefront sensor 10.

It is to be understood that the patent rights arising hereunder are not to be limited to the specific embodiments or methods described in this specification or illustrated in the drawings, but extend to other arrangements, technology, and methods, now existing or hereinafter arising, which are suitable or sufficient for achieving the purposes and advantages hereof.

1. A device for measuring a wavefront, the device comprising:
a detector array configured to detect light passing through an array of lenslets; and
a mask having a fixed pattern comprising an opaque region that is substantially opaque to light from the wavefront and a transmissive region that is transmissive of light from the wavefront;
wherein the mask and the array of lenslets are disposed such that light from the wavefront that is transmitted by the transmissive region is focused onto the detector array by the array of lenslets; and
wherein the mask is adapted to be selectably disposed to any one of a plurality of predetermined positions, wherein a subset of lenslets from the array of lenslets focuses light from the wavefront onto the detector array, depending on which of the plurality of predetermined positions is selected.

2. The device of claim 1, wherein the opaque region is totally opaque to light from the wavefront.

3. The device of claim 1, wherein the array of lenslets is disposed in a two-dimensional grid that samples at least a portion of the wavefront.

4. The device of claim 1, wherein the array of lenslets has a fill factor of one or less.

5. The device of claim 4, wherein the lenslets forming the array of lenslets are spaced substantially equally from one another.

6. The device of claim 4, wherein the lenslets forming the array of lenslets are spaced apart unequally relative to one another.

7. The device of claim 1, wherein the mask comprises two or more transmissive regions that are transmissive of light from the wavefront.

8. The device of claim 7, wherein the fixed pattern is configured such that the spacing between the transmissive regions along each of two orthogonal axes is every nth lenslet of the array, where n is greater than or equal to two.

9. The device of claim 8, where n is equal to two.

10. The device of claim 7, wherein the fixed pattern is configured such that the spacing between the transmissive regions is every nth lenslet of the array, where n is greater than or equal to two.

11. The device of claim 10, where n is equal to two.

12. The device of claim 1, wherein the device is configured to measure a wavefront originating from a human eye.

13. The device of claim 1, wherein the detector array is a charge coupled device (CCD) or a complementary metal oxide semiconductor (CMOS) detector array.

14. The device of claim 1, wherein the detector array further comprises a plurality of detector subapertures, each detector subaperture corresponding to a lenslet in the array.

15. The device of claim 1, wherein the transmissive region transmits light from the wavefront to a region of the detector array that is not transverse relative to the transmissive region.

16. The device of claim 1, wherein the locations of a plurality of focus points of the lenslets is correlated to the nominal slope of the wavefront over the aperture of each lenslet focusing light from the wavefront.

17. The device of claim 1, wherein the transmissive regions have substantially the same shape as the front face of the lenslets.

18. The device of claim 1, wherein the transmissive regions have substantially the same area as the front face of the lenslets.

19. The device of claim 1, wherein the array of lenslets is positioned between the mask and the detector array.

20. The device of claim 1, wherein the mask is positioned between the array of lenslets and the detector array.

21. The device of claim 20, wherein the mask is positioned in a conjugate plane with a pupil.

22. The device of claim 21, wherein the conjugate plane is generated using an image relay system.

23. The device of claim 1, wherein the mask is configured to provide a dynamic range of at least double the dynamic range the device would be capable of without a mask.

24. A device for measuring a wavefront, the device comprising:
a detector array configured to detect light passing through a lens; and
a mask having a fixed pattern, the mask comprising an opaque region that is substantially opaque to light from the wavefront and a transmissive region that is transmissive of light from the wavefront;
wherein the mask and the lens are disposed such that light from the wavefront that is transmitted by the transmissive region is focused onto the detector array by the lens; and
wherein the mask is adapted to be selectably disposed to any one of a plurality of predetermined positions, wherein the lens focuses light from the wavefront onto the detector array, depending on which of the plurality of predetermined positions is selected.

25. The device of claim 24, wherein the opaque region is totally opaque to light from the wavefront.

26. The device of claim 24, wherein the mask comprises two or more transmissive regions that are transmissive of light from the wavefront.

27. The device of claim 26, wherein the fixed pattern is configured such that the spacing between the transmissive regions along each of two orthogonal axes is every nth lenslet of the array, where n is greater than or equal to two.

28. The device of claim 27, where n is equal to two.

29. The device of claim 24, wherein the device is configured to measure a wavefront originating from a human eye.

30. The device of claim 24, wherein the detector array is a charge coupled device (CCD) or a complementary metal oxide semiconductor (CMOS) detector array.

31. The device of claim 24, wherein the lens is positioned between the mask and the detector array.

32. The device of claim 24, wherein the mask is positioned between the lens and the detector array.

33. The device of claim 24, wherein the mask is configured to provide a dynamic range of at least double the dynamic range the device would be capable of without a mask.

34. A method for measuring a wavefront comprising:
providing a wavefront sensor containing a detector array, an array of lenslets, and a mask having a fixed pattern containing one or more opaque regions that are substantially opaque to light from the wavefront and one or more transmissive regions that are transmissive of light from the wavefront;
disposing the array of lenslets such that at least two lenslets from the array of lenslets are configured to focus light from the wavefront onto the detector array; and
moving the mask such that only one of the at least two lenslets focuses light from the wavefront onto the detector array.

35. A method for measuring a wavefront comprising:
providing a wavefront sensor containing a detector array, an array of lenslets, and a mask having a fixed pattern containing one or more opaque regions that are substantially opaque to light from the wavefront and one or more transmissive regions that are transmissive of light from the wavefront;
disposing the mask to a first location such that a first plurality of lenslets from the array of lenslets focuses light from the wavefront onto the detector array; and
moving the mask to a second location such that a second plurality of lenslets from the array of lenslets focus light from the wavefront onto the detector array.

36. The method of claim 35, further comprising moving the mask to a third location such that a third plurality of lenslets from the array of lenslets focuses light from the wavefront onto the detector array.

37. The method of claim 36, further comprising moving the mask to a fourth location such that a fourth plurality of lenslets from the array of lenslets focuses light from the wavefront onto the detector array.

38. A method for measuring a wavefront comprising:
providing a wavefront sensor containing a detector array, a lens, and a mask having an aperture adapted to transmit light from the wavefront;
disposing the mask to a first location, wherein light from a first portion of the wavefront is transmitted through the aperture and is focused by the lens onto the detector array to produce a first signal;
moving the mask to a second location, wherein light from a second portion of the wavefront is transmitted through the aperture and is focused by the lens onto the detector array to produce a second signal.

39. The method of claim 38, further comprising processing the first and second signals with a computer to determine the wavefront measurement.

40. The method of claim 38, further comprising:
using the first signal to determine the slope of the first portion of the wavefront; and
using the second signal to determine the slope of the second portion of the wavefront.

41. The method of claim 38, further comprising moving the mask to a third location, wherein a third portion of the wavefront is transmitted through the aperture and is focused by the lens onto the detector array to produce a third signal.

42. The method of claim 41, further comprising using the third signal to determine the slope of the third portion of the wavefront.

43. The method of claim 41, further comprising moving the mask to a fourth location, wherein a fourth portion of the wavefront is transmitted through the aperture and is focused by the lens onto the detector array to produce a fourth signal.

44. The method of claim 43, further comprising using the fourth signal to determine the slope of the fourth portion of the wavefront.

45. A method for measuring a wavefront comprising:
providing a wavefront sensor containing a detector array, an array of lenslets, and a mask having a fixed pattern containing one or more opaque regions that are substantially opaque to light from the wavefront and one or more transmissive regions that are transmissive of light from the wavefront, wherein the spacing between the transmissive regions along each of two orthogonal axes is every nth lenslet of the array of lenslets, where n is greater than or equal to two;
disposing the mask to a first position such that a first plurality of lenslets from the array of lenslets focuses light from the wavefront onto the detector array;
disposing the mask to a plurality of different positions such that each of the transmissive regions allows light to be focused from the wavefront onto the detector array.

46. The method of claim 45, wherein the step of disposing the mask to a plurality of different positions comprises disposing the mask to (n²−1) different positions.

47. The method of claim 45, where n is equal to two.
